(19) United States
(12) Patent Application Publication
(10) Pub. No.: US 2019/0176573 A1
(43) Pub. Date: Jun. 13, 2019

(54) Heating System with a Radiation Heating Device for a Motor Vehicle, and Method for Operating a Radiation Heating Device

(71) Applicant: Bayerische Motoren Werke Aktiengesellschaft, Muenchen (DE)

(72) Inventors: Philipp HOFMANN, Wiedenzhausen (DE); Patrick OSWALD, Muenchen (DE); Peter SATZGER, Landsberg am Lech (DE)

(21) Appl. No.: 16/274,469

(22) Filed: Feb. 13, 2019

Related U.S. Application Data
(63) Continuation of application No. PCT/EP2017/069531, filed on Aug. 2, 2017.

(30) Foreign Application Priority Data
Aug. 18, 2016 (DE) 10 2016 215 548.2

(51) Int. Cl. B60H 1/22; H05B 1/02

(52) U.S. Cl. CPC B60H 1/2218; H05B 1/0236; H05B 2203/032; B60H 2001/2256; B60H 2001/2231

(57) ABSTRACT

A method is provided for operating a radiation heating device for a heating system of a motor vehicle. The radiation heating device has an electrically operable heating element for providing a heating temperature at a heating surface. The method operates the heating element for the purposes of providing heating power in normal operation, checks whether there is contact between the heating surface and a body part, and reduces the heating power of the heating element if contact with the body part is identified.

### CROSS REFERENCE TO RELATED APPLICATIONS

This application is a continuation of PCT International Application No. PCT/EP2017/069531, filed Aug. 2, 2017, which claims priority under 35 U.S.C. § 119 from German Patent Application No. 10 2016 215 548.2, filed Aug. 18, 2016, the entire disclosures of which are herein expressly incorporated by reference.

### BACKGROUND AND SUMMARY OF THE INVENTION

The invention relates to heating systems for motor vehicles, specifically having heating devices which direct thermal energy in the form of thermal radiation towards vehicle occupants. The present invention further relates to measures for protection against burns, in the event of contact with such a heating device.

In addition to conventional fan heating systems in motor vehicles, radiation heating devices such as, for example, infrared radiators, which emit thermal radiation and direct the latter towards vehicle occupants, can be provided alternatively or additionally. Radiation heating devices essentially comprise a heating surface, which is heated to a temperature between 40 and 150° C., by means of which thermal radiation is directed towards the vehicle occupants.

From document DE 10 2013 2014 554 A1, for example, a heating system having infrared heating surfaces is known, which is provided additionally to the conventional central heating system in the vehicle.

In DE 198 085 71 B4, a supplementary heating device to a conventional heating and air-conditioning system is provided with an infrared radiator, which is installed in the vehicle passenger compartment by way of a decentralized heating system.

Moreover, from document DE 10 2013 2014 548 A1, an electric heating device for use in a motor vehicle is known, in which infrared radiation is emitted in the vehicle passenger compartment.

Conversely to previously provided heating surfaces in motor vehicles, such as e.g. vehicle seat heaters, steering wheel heaters and arm rest heaters, in which the transmission of heat to the vehicle occupants is generally executed by means of contact with the heating surface, radiation heating devices require a significantly warmer heating surface, in order to achieve an effective heating effect for vehicle occupants.

In principle, this entails the risk that vehicle occupants, in the event of prolonged or sufficiently long contact with the radiation heating device, might sustain burns, if the heating surface assumes a relatively high temperature, for example in excess of 43° C. (c.f. DIN 13732).

Moreover, prolonged contact with a heating surface, even in the event of moderate heating surface temperatures, can result in burns. A significant proportion of persons have a restricted sensitivity to temperature, or suffer from a heat sensitivity disorder, such that for those affected prolonged contact with a heating surface, in consequence, is not perceived, or is perceived too late. It is therefore important to ensure that any injury to vehicle occupants resulting from contact with a heating surface is prevented.

From document WO 2016/074953, a steering wheel is known, having a sensor installation for the occupancy detection of a heated contact surface. The contact surface constitutes an element of the outer covering of the steering wheel. A sensor heating layer is further provided, in which at least one sensor electrode for occupancy detection and at least one heating wire are arranged. A specific potential can be applied to a potential layer, which is arranged between the sensor heating layer and a steering wheel frame.

The object of the present invention is the provision of a heating system having a radiation heating device in a motor vehicle, wherein the protection of a vehicle occupant against burning by a heating surface of the radiation heating device is provided.

This and other objects are achieved by a radiation heating device for use in a motor vehicle, by a heating system, and by a method for operating the radiation heating device, in accordance with the embodiments of the invention.

According to a first aspect, a method is provided for operating a radiation heating device in a heating system of a motor vehicle, wherein the radiation heating device comprises an electrically operable heating element for providing a heating temperature on a heating surface. The method includes the following steps of:

operating the heating element for delivery of heating power in normal duty;
checking whether there is contact between the heating surface and a body part;
reducing the heating power of the heating element if contact with the body part is identified.

According to an aspect of the above-mentioned radiation heating device, the latter is equipped with a contact detection facility, in order to initiate a power reduction or switch-off of the radiation heating device for the duration of contact. This permits the temperature of the heating surface of the heating device to be reduced to the extent that any burning, specifically in the event of prolonged contact with a body part, can be prevented.

It can be provided that the heating power of the heating element is reduced, if contact with a body part is detected which exceeds a specified duration of contact.

The heating element can further be operated, wherein the heating power is adjusted to a specified setpoint heating temperature, in accordance with a temperature control function.

The heating power of the heating element can further be reduced wherein, in the event of contact between the heating surface and a body part, a safety temperature is specified by the temperature control function which is lower than the setpoint heating temperature.

It can be provided that the check for the presence of contact between the heating surface and a body part is executed, wherein a capacitance variation on a conductor in the heating device, specifically of a heating conductor in the heating element, is determined in relation to the environment.

Specifically, determination of the capacitance variation can be executed in a time interval during which the conductor of the heating device, specifically in response to the temperature control function or in the event of pulse width-modulated actuation, is de-energized.

According to one embodiment, for the determination of the capacitance variation, a voltage can be applied to a connecting line of the heating element, and a time interval for the achievement of a specified detection voltage threshold value on said connecting line, or on another connecting line of the heating element, can be determined, wherein contact with a body part is detected by the comparison of the time interval thus determined with a reference time interval.

It can be provided that the heating element is restored to operation in accordance with normal duty, if no contact with a body part is detected.

According to a further aspect, a heating system for a motor vehicle is provided, comprising:

a radiation heating device having an electrically operable heating element for providing a heating temperature on a heating surface; and
a control unit, comprising:

a power electronics circuit, for providing heating power on the heating element, and

a safety unit, which is configured to check for the presence of contact between the heating surface and a body part, and to actuate the power control circuit for the reduction of the heating power of the heating element, if contact with a body part is detected.

Moreover, the safety unit can be connected to the power electronics circuit, such that a capacitance variation on a conductor in the heating device, specifically of a heating conductor in the heating element, can be determined in relation to the environment.

According to one embodiment, the power electronics circuit can be configured for the complete electrical isolation from the supply voltage of an electrical connection to the heating element, specifically via electrical connecting lines, wherein the safety unit is designed, for the identification of a capacitance variation, to apply a voltage to one of the connecting lines of the heating element and to determine a time interval to the achievement of a specified detection voltage threshold value on said connecting line, or on another connecting line of the heating element, wherein contact with a body part is identified by the comparison of the time interval thus determined with a reference time interval.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic representation of a heating system having a radiation heating device.

FIG. 2 is a flow diagram for the illustration of a method for operating a radiation heating device.

### DETAILED DESCRIPTION OF THE DRAWINGS

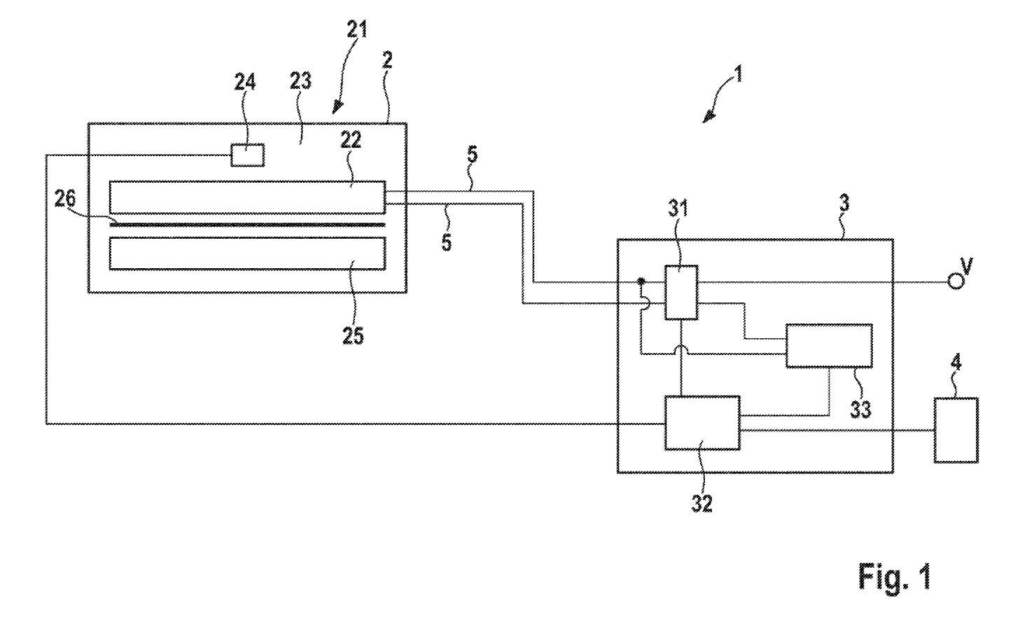

FIG. 1 shows a heating system 1 for use in a motor vehicle, which executes the heating of a vehicle passenger compartment by means of a radiation heating device 2. The radiation heating device 2 comprises a heating surface 21, which is preferably to be heated to temperatures between 40 and 100° C., in order to heat the vehicle passenger compartment, specifically by the emission of thermal radiation.

The radiation heating device 2 further comprises a heating element 22 which, in the form of an electrically operable heating element, can be heated up by the infeed of electrical energy. Specifically, the heating element 22 can be a heating wire, a heating conductor, or any otherwise resistive heating conductor, for the delivery of a corresponding heating power in response to the application of electric power.

Between the heating element 22 and the heating surface 21, a comfort layer 23 can be provided, which prevents direct contact with the heating element 22, and ensures the most consistent possible heat distribution over the heating surface 21. The material of the comfort layer is preferably non-electrically conductive.

In the comfort layer 23, but specifically between the heating surface 21 and the heating element 22, a temperature sensor 24 is provided, which delivers a temperature reading in the form of an appropriate electrical variable. The temperature reading is indicative of the temperature of the heating surface 21. The temperature sensor 24 can be configured, for example, as a NTC- or PTC-resistor, and delivers the temperature reading in the form of an electrical resistance.

On the opposite side of the heating element 22 to the heating surface 21, an insulating element 25 is provided, in order to reduce the input of heat to components arranged opposite the heating surface 21. Moreover, on the side of the heating element 22 facing the heating surface 21, a reflective layer 26 can be arranged, which reflects thermal radiation emitted by the heating element 22 in the direction of the heating surface 21.

The radiation heating device 2 is connected to a control unit 3. The control unit 3 incorporates a power electronics circuit 31, which is connected to the heating element 22 by means of electrical connecting lines 5, in order to deliver electric power for conversion into heating power in the heating element 22. To this end, the power electronics circuit 31 is coupled to an external energy source V. The external energy source V, in a motor vehicle, can be an on-board network, which delivers a specified voltage e.g. of 14 or 48 V, wherein the power electronics circuit 31 delivers electric power to the heating element 22 in an appropriate manner.

The power electronics circuit 31 can deliver a specified power rating to the heating element in a switched-mode arrangement. To this end, the power electronics circuit 31 can comprise a converter or inverter, specifically in the form of an H-bridge circuit or similar. Preferably both electrical connecting lines 5 are connected to the heating element 22.

A temperature control function 32 is moreover provided, which receives the temperature reading from the temperature sensor 24, and actuates the power electronics circuit 31 in a corresponding manner, in order to provide a specified setpoint heating temperature on the heating surface 21. To this end, the temperature control function 32 can execute a control, e.g. in the form of a two-step control, in accordance with the specified setpoint heating temperature. The setpoint heating temperature to be set can be dictated externally by a user, e.g. by means of an appropriate operator control 4, e.g. a rotary button, or can be determined by an instruction from a temperature-control device, with reference to a predetermined setpoint temperature.

The infeed of heating power can be executed by the actuation of the power electronics circuit 31 by means of pulse-width modulation, i.e. by the alternating application of electric power to the heating element 22 and the switch-off of the heating element 22. Accordingly, within a specified cycle time of, for example, a few seconds, e.g. between 10 ms and ten seconds, in accordance with a specified pulse duty factor, the heating element 22 is switched on for a given time interval, and switched off for the remainder of the cycle time. The pulse duty factor thus indicates the average heating power which is delivered by the heating element 22.

A safety unit 33 is provided, which is electrically connected to the connecting lines 5 between the power electronics circuit 31 and the heating element 26. The safety unit 33, by an appropriate method, can detect a variation in capacitance in the event of proximity or contact of a body part with the heating surface 21, and can instruct the control unit 32 accordingly to adjust the temperature of the heating surface 21 to a lower safety temperature. Accordingly, as soon as the safety unit 33 has detected the contact of a body part with the heating surface 21, the setpoint heating temperature set by the operator control 4 is no longer considered and, instead, the safety temperature is considered as the setpoint variable by the temperature control function 32.

Contact detection can then be executed during the switch-off periods of the heating element 22, as the power electronics circuit 31 isolates the two connecting lines to the heating element 22 from the supply source V. During a switch-off period, the safety unit 33, by means of one of the supply voltages, can apply a potential, for example +5 V, to the heating element 22 and, on the corresponding other supply line 5, can measure a time interval with effect from which a specific detection voltage threshold value, which is dependent upon the detection voltage, is exceeded. The voltage characteristic on the other supply line 5 is dependent upon the capacitance of the heating element 22 in relation to adjoining ground potentials or body parts.

Upon the detection of a variation in the measured time interval, by comparison with a specified reference time interval, a change in the capacitive environment of the heating device 2 can be concluded, which is interpreted as the proximity of, or contact with a body part. If a deviation of the measured time interval from the reference time interval is detected, which corresponds to a reference capacitance in the environment of the heating device 2 in the absence of body parts, contact with the heating surface 21 can thus be concluded. The heating power, in response to an instruction for a correspondingly prioritized safety temperature on the temperature control function 32, is then reduced accordingly. The reduced safety temperature is thus implemented by said temperature control circuit by means of a correspondingly reduced heating power, or switch-off of the heating element 22.

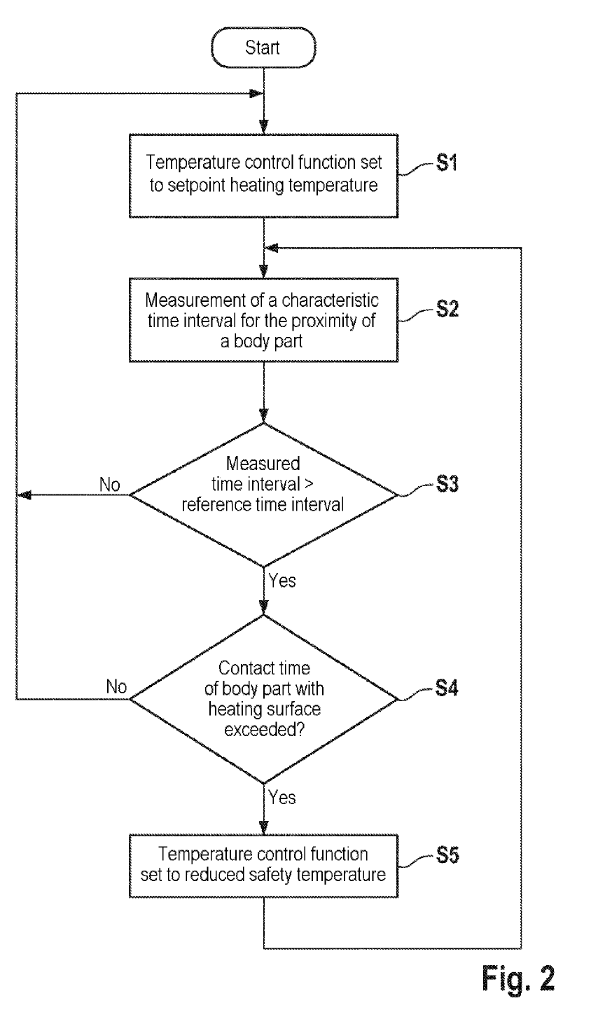

FIG. 2 shows a schematic representation of a flow diagram for the illustration of the method according to the invention.

In step S1, a temperature control function can firstly be executed, which is based upon the instruction for the setpoint heating temperature. Accordingly, an average electric power is fed to the heating element 22, corresponding to the heating power to be provided for the maintenance of the setpoint heating temperature on the heating surface 22. The infeed of heating power can be executed cyclically, e.g. by means of pulse-width modulation, wherein heating power is applied by connection to, and separation from the electrical supply source V by the power electronics circuit 31. Alternatively, only a fixed and predetermined heating power can be delivered by cyclical actuation, by means of pulse-width modulation.

As the heating element 22, during switch-off periods, is completely isolated from the supply source V, the heating element 22 can be employed for contactless measurement of contact on the heating surface 22. This measurement is executed capacitively in step S2 within the switch-off periods, by the application of a voltage to one of the connecting lines 5 (terminals) of the heating element 22, and the measurement of the time interval between the time of application of the voltage and the time at which the specified detection voltage threshold value has been achieved on the connecting line 5, or on the corresponding other connecting line 5 of the heating element 22.

By a comparison of the measured time interval with a specified reference time interval in step S3, it can be detected that a body part has entered the immediate environment of the heating surface 21, or has contacted the latter.

If it has been established that the measured time interval is greater than the specified reference time interval (the “Yes” option), contact with the heating surface or contact of the heating surface with a body part is concluded, and the method proceeds with step S4. Otherwise, the sequence returns to step S1.

In step S4, a check can be executed as to whether, since the initial detection of contact with the heating surface, a specified contact time has elapsed. If this is not the case, the sequence returns to step S1. Otherwise, the method proceeds with step S5.

In step S5, the temperature control function 32 can be instructed to actuate the power electronics circuit 31 with a reduced heating power, e.g. by the specification of a safety temperature which is reduced in relation to the setpoint heating temperature, or to switch off the heating element 22 altogether.

Otherwise, i.e. if the time interval detected for the measurement of contact is shorter than the reference time, the sequence returns to step S1, such that the operation of the temperature control function 32 in normal duty, i.e. in consideration of the setpoint heating temperature specified by means of the operator control 4, can be resumed.

The power electronics circuit 31 can further incorporate a current measurement function, which monitors whether the current flowing during the switch-on periods lies within a specified setpoint current range for a specified supply voltage. If the measured heating current deviates from this range, damage is assumed, and the power electronics circuit 31 is switched off accordingly.

### LIST OF REFERENCE SYMBOLS

1 Heating system
2 Radiation heating device
21 Heating surface
22 Heating element
23 Comfort layer
24 Temperature sensor
25 Insulating element
26 Reflective layer
3 Control unit
31 Power electronics circuit
32 Temperature control function
33 Safety unit
4 Operator control
5 Electrical connecting lines
V Energy source

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a radiation heating device in a heating system of a motor vehicle, wherein the radiation heating device comprises an electrically operable heating element for providing a heating temperature on a heating surface, the method comprising the steps of:
operating the heating element for delivery of heating power in normal duty;
checking whether there is contact between the heating surface and a body part; and
reducing the heating power of the heating element if contact with the body part is identified.

2. The method as claimed in claim 1, wherein
the heating power of the heating element is reduced if contact with the body part is detected which exceeds a specified duration of contact.

3. The method as claimed in claim 1, wherein
the heating element is operated such that the heating power is adjusted to a specified setpoint heating temperature in accordance with a temperature control function.

4. The method as claimed in claim 3, wherein
the heating power of the heating element is reduced wherein, in an event of contact between the heating surface and the body part, a safety temperature is specified by the temperature control function which is lower than the setpoint heating temperature.

5. The method as claimed in claim 1, wherein
the checking for contact between the heating surface and the body part is executed by determining a capacitance variation on a conductor in the radiation heating device in relation to the environment.

6. The method as claimed in claim 5, wherein
the conductor in the radiation heating device is a heating conductor in the heating element.

7. The method as claimed in claim 5, wherein
the determining of the capacitance variation is executed in a time interval during which the conductor of the heating device is de-energized.

8. The method as claimed in claim 7, wherein
the determining of the capacitance variation is executed in response to a temperature control function or in an event of pulse width-modulation actuation.

9. The method as claimed in claim 5, wherein
for determining the capacitance variation, a voltage is applied to a connecting line of the heating element, and a time interval for achieving a specified detection voltage threshold value on said connecting line, or on another connecting line of the heating element is determined, wherein contact with the body part is detected by comparing the time interval thus determined with a reference time interval.

10. The method as claimed in claim 9, wherein
the heating element is restored to operation in accordance with normal duty, if no contact with the body part is detected.

11. A heating system for a motor vehicle, comprising:
a radiation heating device having an electrically operable heating element for providing a heating temperature on a heating surface;
a control unit, comprising:
a power electronics circuit providing heating power on the heating element, and
a safety unit, which is configured to check for presence of contact between the heating surface and a body part, and to actuate the power control circuit for reducing the heating power of the heating element if contact with the body part is detected.

12. The heating system as claimed in claim 11, wherein
the safety unit is connected to the power electronics circuit such that a capacitance variation on a conductor in the radiation heating device is determinable in relation to the environment.

13. The heating system as claimed in claim 12, wherein
the conductor in the radiation heating device is a heating conductor in the heating element.

14. The heating system as claimed in claim 12, wherein
the power electronics circuit is further configured for complete electrical isolation of an electrical connection to the heating element,
the safety unit is further configured for identifying a capacitance variation, applying a voltage to a connecting line of the heating element and determining a time interval to achieve a specified detection voltage threshold value on said connecting line, or on another connecting line of the heating element, wherein contact with the body part is identified by comparing the time interval thus determined with a reference time interval.

15. The heating system as claimed in claim 14, wherein
the electrical connection to the heating element is via electrical connecting lines.
